(19) United States
(12) Patent Application Publication
(10) Pub. No.: US 2010/0153521 A1
(43) Pub. Date: Jun. 17, 2010

(54) Method and Device for Providing Offline Web Services

(76) Inventors: Kar-Wing Edward Lor, Hong Kong (CN); Hiu Fung Lau, Hong Kong (CN); Tseng Wai Leung, Hong Kong (CN); Nim Yan Lee, Hong Kong (CN); Tai Wai Chan, Hong Kong (CN); Siu Man Chan, Hong Kong (CN)

Correspondence Address: WELLS ST. JOHN P.S., 601 W. FIRST AVENUE, SUITE 1300, SPOKANE, WA, 99201, US

(21) Appl. No.: 12/335,215

(22) Filed: Dec. 15, 2008

(51) Int. Cl. G06F 15/16

(52) U.S. Cl. 709/219

(57) ABSTRACT

A method for offline social networking includes copying at least a part of an online web service profile stored on a server to an offline web service profile stored on a mobile device. Later when the mobile device is in an offline condition, performing one or more web service functions on the mobile device using the offline web service profile stored on a mobile device, and finally connecting with the server and repeating at least one of the one or more web service functions using the online web service profile stored on the server.

### BACKGROUND OF THE INVENTION

1. Field of the Invention

The current invention relates to offline web services, and in particular to a method and device for providing offline web services. The invention also relates to a method of synchronizing online and offline web service profiles.

2. Background Information

The internet has become an integral part of the everyday lives of many individuals. Most internet users are members of some form of web-based service, web forum or online community, which allows them to interact with other internet users. All of these services require users to have an online profile, which is stored on a remote internet server and updated and changed with a user's use of the web service, forum or interactions within an online community. Many web services, forums and online communities can also now be accessed via wireless mobile devices, which have further expanded their popularity and use.

One of the significant drawbacks to the use of online web services via mobile devices is the coverage bandwidth and expense of wireless internet connectivity. Groups of users may often find themselves in a location with no or poor public wireless internet connectivity. Moreover, web services and online communities are particularly popular amongst the younger generation who are more likely to be unable or unwilling to pay high fees for mobile wireless internet connections.

### SUMMARY OF THE INVENTION

Accordingly, there exists a need for a method and device for providing offline web services, and in particularly for a method of synchronizing an offline web service profile and a corresponding online web service profile.

There is disclosed herein a method for providing offline web services, such as social networking and user generated content sharing, the method comprising copying at least a part of an online web service profile stored on a server to an offline web service profile stored on a mobile device, performing one or more web service functions on the mobile device using the offline web service profile stored on a mobile device, and connecting with the server and repeating at least one of the one or more web service functions using the online web service profile stored on the server.

There is also disclosed herein a method for synchronising online and offline web service profiles, comprising in a first online condition: copying an online web service profile to an offline web service profile stored on a mobile device, in an offline condition: recording details of web service functions performed using the offline web service profile, and in a second online condition: performing one or more of the stored web service functions using the online web service profile.

A mobile device for participating in offline social networking has an offline social networking application module that is programmed to perform the above methods.

Further aspects of the invention will become apparent from the following description and drawings.

### BRIEF DESCRIPTION OF THE DRAWINGS

An exemplary form of the present invention will now be described by way of example only and with reference to the accompanying drawings, in which:

FIG. 1 schematically illustrates a plurality of mobile devices, in a local peer group network, and various interactions and user generated content sharing activities between devices,

FIG. 2 is a block flow diagram of online preparations for offline social networking in accordance with the invention,

FIG. 3 is a block flow diagram of offline social networking in accordance to the invention,

FIG. 4 is a block flow diagram of subsequent synchronization between offline and online profiles according to the invention,

FIG. 5 is a schematic communication flow diagram of successful synchronization of offline activities between two users, and

FIG. 6 is a schematic communication flow diagram of unsuccessful synchronization of offline activity between two users.

### DESCRIPTION OF THE PREFERRED EXAMPLE

The invention will now be illustrated as practiced in the context of an online community such as social networking sites like those provided by MySpace, Facebook, and ORKUT and user generated content sharing sites like YouTube, Kodak Gallery and Flickr to name just a few. However, this is not intended to limit the scope or functionality of the invention. The invention provides a method and a device for a group of two or more users belonging to the same online web service to interact, communicate and share user generated content via a peer group local network or personal area network without an internet connection. In particular, the invention provides for the synchronization between online and offline profiles both before and after any offline activity so that users may update their online profile with offline activity when an internet connection is again available. The skilled addressee will quickly understand and appreciate from the following description that such device and methods have applications in other forms of online web services, in particular so called Web 2.0 services, which might be periodically undertaken offline when no internet connection is available or it is undesirable to connect to the internet due to quality of service and/or cost.

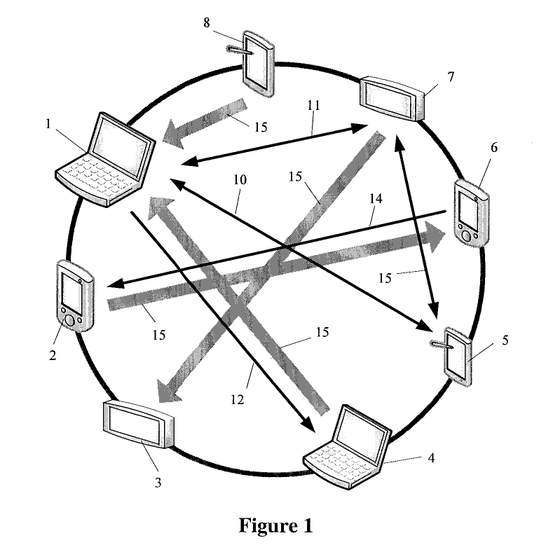

FIG. 1 depicts an overview of a plurality of mobile devices, mobile phones, PDAs, handheld computers and laptop computers all connected via a local peer group network. The type or protocol of the network is not important to the invention. The network could be via Wi-Fi, bluetooth or other means. A Wi-Fi network may be either infrastructure mode or ad hoc mode in which wireless devices are able to communicate with each other either directly or through an access point or another node in the network. Moreover, in a most basic form the network may even be two devices communicating with each other via infrared (IR) means for the sharing of user generated content. What is important to the invention is that the network does not have, or does not need to have, internet connectivity. This does not mean though that the network or one or more devices participating in the network cannot have an available internet connection. An internet connection may be available to one or more devices participating in the network but for some reason, such as available bandwidth, quality of service, cost and/or application blocking/web site filtering by the firewall the available internet connection is not used. In the description the term “offline” means not connected with the internet or not connected with a web based service via the internet, as the context requires.

Referring still to FIG. 1, for the purpose of the invention two or more users of the mobile devices 1, 2, 3, 4, 5, 6, 7, 8 participating in a network belong to an online social networking site, for example, Facebook, and wish to interact and share user generated content via their Facebook profiles in an offline mode. Such interactions include typical low bandwidth social networking activities such as viewing friends' profiles 10, adding/inviting friends 11, leaving comments 12, forming/inviting/joining groups 13, viewing and tagging pictures 14, and higher bandwidth activities such as user generated content sharing 15. In order to facilitate such offline activity the users must at an earlier time when their mobile device is connected to the internet downloaded or copy their online social networking (e.g. Facebook or MySpace) profile and personal content, such as video, photos blogs and the like, to their mobile device. The copy of the profile on the mobile device is an offline version of the online profile. The mobile device is provided with a client application which supports the offline social networking profile and facilitates all services, functions and interactions of the social networking site on the mobile device. The user is then able to use the stored offline social networking profile and the client application to experience the social networking service while participating in a local peer group network with no internet connection or with internet connectivity disabled or turned off. During the offline activity the client application operated on the mobile device records details of all activity and changes in the offline social networking profile.

After offline activity the user can synchronize the offline social networking profile with the online social networking profile by reconnecting the mobile device to the internet. A number of online service and community websites are based on an OpenSocial and other application programming Interfaces (APIs) which allow third party applications to access data and core functions of the sites directly rather than users needing to go through traditional web browser based access. However, such access does not allow third party applications to synchronize or change online profiles by direct manipulation of profile data. In the current invention the mobile device client application synchronizes the offline profile with the online profile by connecting to the online profile with the users authentication information (user names and passwords) and replicating all offline activity from previously recorded offline activity data. For example, if during offline activity a user invited friends to join a group then during synchronization the mobile device client application will replicate the invitation for friends to join the group in the online environment. Similarly if other activities such as tagging photos, updating a user profile, leaving comments and/or sharing photos and access to other people's photos were done during offline activity these actions will be replicated by the mobile device client application during re-synchronization in the online environment.

Interaction and user content sharing on social network sites, obviously, involves actions and activities by two or more parties. For example, a user can invite another user to become a friend but the two users do not officially become friends until the second user accepts the invitation, with such activities recorded on the web service's server. The client application on a mobile device can only access the online user profile of the owner and user of that device and cannot initiate and perform tasks or updates to other online user profiles with which the owner/user interacts. Therefore, certain activities and functions performed offline cannot be fully synchronized online until both users involved in the activity or interaction have connected their mobile devices to the internet for re-synchronization purposes. For example, during an offline social network session user A invites user B to become a friend. User B accepts the invitation and in the offline environment the offline profiles of users A and B are updated to reflect that two users are friends. If user B connects his or her mobile device to the internet before user A then this interaction cannot be updated on user B's profile because user B did not initiate the invite but only accepted the invite. The client application on user B's mobile device cannot accept an invitation in the online environment which has not yet been issued by user A in the online environment. Therefore, this activity would not be synchronized in user B's online profile during the connection to the internet. During subsequent connections to the internet the mobile client application on user B's mobile device could continue to check whether the invitation to become a friend has been issued in the online environment and as soon as it has, the mobile client application will automatically accept the invitation completing that part of the online profile synchronization. Correspondingly, when user A connects his or her mobile device to the internet and the mobile client application issues the friend invite in the online environment synchronization of the online profile is not complete until user B connects the mobile device and the invitation has been accepted.

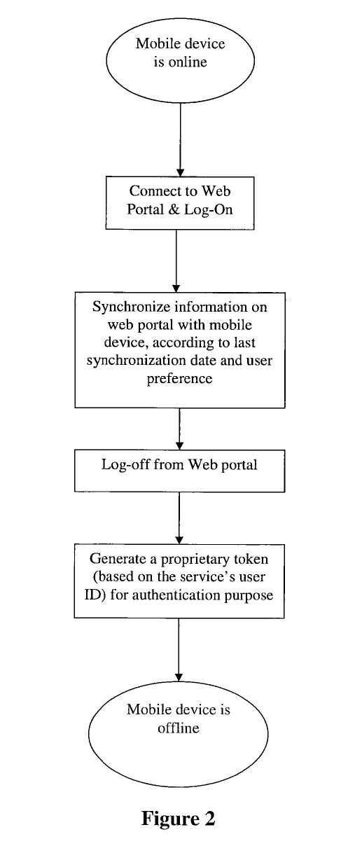

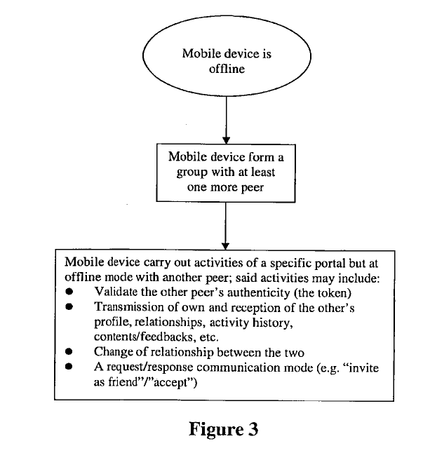

FIGS. 2-4 are flow block diagrams of the method for facilitating offline web services described above. The method is performed by a client application resident on the mobile device. Referring to FIG. 3, initially the mobile device is connected to the internet and the mobile client application started for synchronizing an offline profile with an online profile. The mobile client application connects to the social network site web portal and logs on using pre-input user authentication information, for example user name and password. The client application synchronizes the offline profile on the mobile device with the online profile according to the last synchronization date and user preferences. User preferences may include details of those parts of the users profile to be synchronized between the online and offline profiles. The user may synchronize the entire profile or any part of the profile such as personal information of the user and one or more of photographs or other user generated content, friends, groups, comments (for example user's wall in Facebook), contact list, access permission of personal contents, blogs. After synchronization is completed the client application logs off from the web portal. In the preferred embodiment the client then generates a proprietary token for authentication purposes. This token (or key) has the following function. When the user of a mobile device engages in offline social networking interactions with another user, the user may wish to confirm that the other user has a genuine online profile for the social networking site in question. The token generated by the mobile device client application acts as authentication that the user has a valid online profile matching the offline profile being used. After pre-offline mode synchronization and token generation are complete the mobile device can be disconnected from the internet.

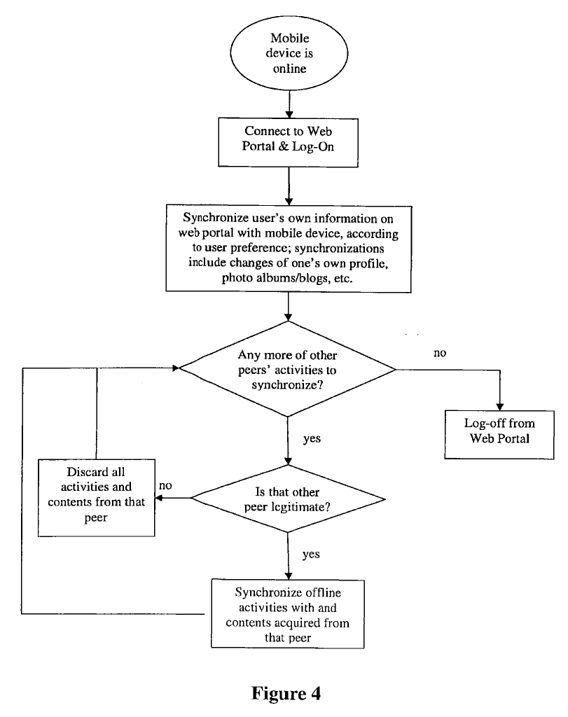

Referring now to FIG. 4, the mobile device client application also provides a platform for replication the social networking site core functions, look and feel in the offline environment. The user connects with a network and forms a network group with at least one other mobile device. The mobile device client application may have a scan mode which broadcasts its presence and listens for responses or broadcasts from other client applications in mobile devices thereby identifying other devices/users that may participate in offline social networking interactions. The mobile device client application then facilitates all the functions of the specific social networking portals (for example, Facebook) with the other users. Validity of the other user's online profile is confirmed using tokens. Activities may include, but are not limited to, transmission of own and receipt of other people's profile, relationships, activity, history, contents/feedback, comments and user generated content sharing. Relationships between users can also be changed via requests/responses to various communications including invites as friends and invites to join groups. During all offline activity the mobile device client application records and logs all offline activity and changes in the offline user profile so that these can be later re-synchronized with the online social networking profile.

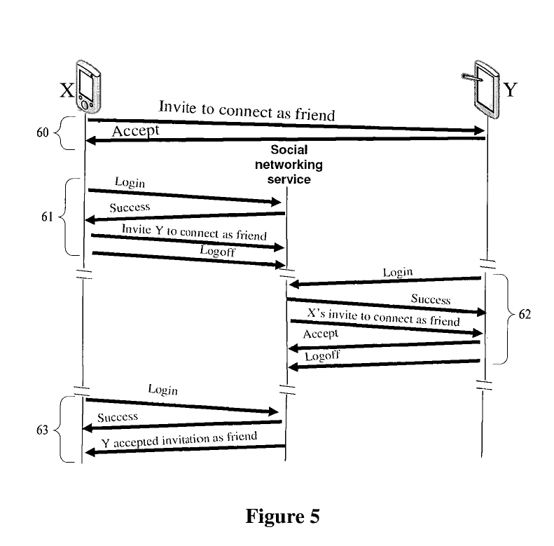

Referring to FIG. 5 after offline activity the online profile must be synchronized with the offline profile in order to keep the online profile up to date. The mobile device is connected to the internet and the mobile client application connects to the online social networking site portal and logs on using user authentication information. The mobile client application can directly update the online user profile with any changes made in the offline profile by the user which do not require confirmation or activity of another social network user. This could include the addition of photographs and another user generated content to the user's profile which were added to the offline profile on the mobile device and changes to personal information contained in the user's profile such changes to the users avatar. The mobile client application then checks whether there is any activity involving other users that which needs to be synchronized, for example, invitations to joining groups or as friends or acceptance of invitations issued by the current user. If no such further synchronization is required then the mobile client application can log off from the online portal. If synchronization involving other users is required then the mobile client application confirms legitimacy of the other user via the user token or by searching for the user name within the social networking site. If legitimacy of the other user cannot be confirmed then all activity involving that user is discarded. If legitimacy of the other user is confirmed then synchronization of that user activity can be undertaken subject to timely connection and issuing of invitations and acceptances by the other user. If offline activity involves more than one other user then steps are repeated for confirming legitimacy of each other user and performing synchronization or discarding activity involving those users.

FIG. 5 illustrates successful synchronization of offline activities including two users, X and Y. In offline mode 60 user X invites user Y to become a friend. User Y receives the invitation and accepts the invitation. X and Y become friends in their offline profiles. Later 61, the mobile device of X is connected to the internet and the device client application successfully logs into the social networking site. The client application initiates synchronization by sending an invite to user Y via the online social network service. The user X device then logs off. At a later date 62 the device of user Y is connected to the internet and the device client application of Y successfully logs in to the social networking site. The client application knows that it needs to accept an invite to be a friend in order to update the online profile and looks for the invite from X. On finding the invite from X, Y accepts the invite from X and logs off. A little bit later 63 than this user X logs on to the social network site again and the client application of X confirms Y's acceptance as a friend and updates X's online profile.

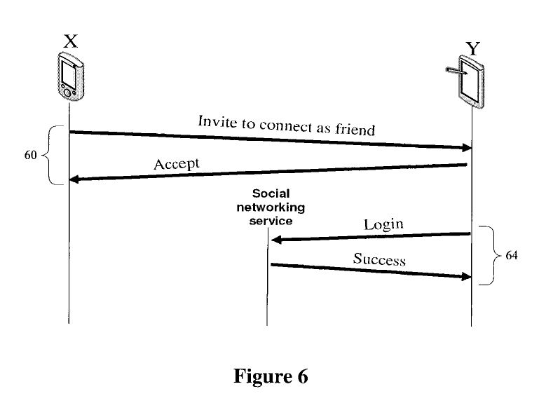

Turning now to FIG. 6 which shows an initial unsuccessful synchronization of offline activity involving two users X and Y. During the offline session 60 X invites Y to become a friend and Y accepts. Later 64, Y logs in to the social networking site for the purpose of updating the online user profile. However, X is yet to connect to the internet and log into the site and so there is no online invitation for acceptance. Therefore online synchronization of this activity fails and Y must log in again at a later date after X has successfully logged in and issued the required online invitation.

As the popularity of online communities and social networking continues to grow, it is envisage that portable devices having a primary purpose as a mobile social networking interface will become available. It is envisage that such a device will have a large screen for displaying photos and other user generated content and dedicated client applications for interfacing with online social networking websites. The inventors further envisage that such a device would also incorporate offline social networking functionality as described above. Such functionality is easily incorporated into mobile devices for use with online services based on the OpenSocial and other APIs without specific cooperation from the online community service providers.

The inventors also envisage that the invention will provide a new and improved way to share large amounts of user generated content. Currently such user generated content is uploaded to the online profile of a particular user and then is made available for download again by other users who are friends or in common groups with the uploading user. In the mobile environment users would pay to first upload the content and then to download the content again. User generated content can be shared more quickly and cheaply between users using direct peer-to-peer communications and later synchronization of online and offline profiles in accordance with the current invention.

The inventors also envisage that members of user generated content sites such as You Tube may save favorite content from the site, whether generated by themselves or others, to the offline profile on the mobile device to share with others in an offline network.

What is claimed is:—

1. A method for offline social networking comprising:
copying at least a part of an online web service profile stored on a server to an offline web service profile stored on a mobile device,
performing one or more web service functions on the mobile device using the offline web service profile stored on a mobile device, and
connecting with the server and repeating at least one of the one or more web service functions using the online web service profile stored on the server.

2. The method of claim 1 wherein copying the online web service profile to the offline web service profile comprises copying personal information of the user and one or more of friends, groups, comments, contact list, access permissions and user generated content stored in the online profile.

3. The method of claim 1 wherein after copying the online web service profile to the offline web service profile comprises copying the online web service profile to the offline web service profile and generating an authentication key for the offline web service profile.

4. The method of claim 1 wherein copying the online web service profile to the offline web service profile comprises

5. The method of claim 1 wherein performing one or more web service functions on the mobile device comprises joining the mobile device with a peer group network and sharing at least part of the offline user profile with one or more members of the peer group network.

6. The method of claim 1 wherein performing one or more web service functions on the mobile device comprises recording details of web service functions performed using the offline web service profile.

7. The method of claim 1 wherein connecting with the server and repeating at least one of the one or more web service functions using the online web service profile stored on the server includes updating the online web service profile with changes made to the offline web service profile.

8. The method of claim 5 wherein connecting with the server and repeating at least one of the one or more web service functions using the online web service profile stored on the server includes authenticating an online profile of the one or more members of the peer group network.

9. A method for synchronising online and offline web service profiles, comprising:
in a first online condition: copying an online web service profile to an offline web service profile stored on a mobile device,
in an offline condition: recording details of web service functions performed using the offline web service profile, and
in a second online condition: performing one or more of the stored web service functions using the online web service profile.

10. The method of claim 9 wherein the first and second online conditions comprise the mobile device being connected with an internet based web service.

11. The method of claim 9 wherein during the first or second online conditions the mobile device is connected directly with an internet service.

12. The method of claim 9 wherein during the first or second online conditions the mobile device is connected with a computer having an internet connection.

13. The method of claim 9 wherein copying the online web service profile to the offline web service profile comprises copying personal information of the user and one or more of photographs, friends, groups, comments, contact list and access permissions stored in the online profile.

14. The method of claim 9 wherein copying an online web service profile to an offline web service profile on a mobile device comprises synchronising the offline web profile with the online web service profile.

15. The method of claim 9 wherein the offline condition comprises the mobile device being connected with one or more other devices in a local or personal area network for communicating and sharing of user generated content.

16. The method of claim 9 wherein performing one or more of the stored web service functions using the online web service profile comprises authenticating an online profile of the one or more other members of a network participating in the offline condition web service functions.

17. A mobile device for participating in offline social networking, the mobile device comprising an offline social networking application programmed to perform the method of claim 1.
